(19) United States
(12) Patent Application Publication
(10) Pub. No.: US 2019/0256207 A1
(43) Pub. Date: Aug. 22, 2019

(54) WIRED DRONE GROUP

(71) Applicant: Ebara Corporation, Tokyo (JP)

(72) Inventors: Motohiko NOHMI, Tokyo (JP); Yumiko SEKINO, Tokyo (JP)

(73) Assignee: Ebara Corporation, Tokyo (JP)

(21) Appl. No.: 16/344,058

(22) PCT Filed: Oct. 30, 2017
(86) PCT No.: PCT/JP2017/039071

§ 371 Date: Apr. 23, 2019

(30) Foreign Application Priority Data
Nov. 7, 2016 (JP) 2016-217345

(51) Int. Cl. B64C 39/02; B64C 37/02; B64C 19/02; B64F 3/00

(52) U.S. Cl. CPC B64C 39/024; B64C 37/02; B64C 19/02; B64C 2201/127; B64C 2201/148; B64C 2201/143; B64F 3/00

(57) ABSTRACT

The present invention relates to a drone which is an unmanned mobile which can move in the air or in the water or in both areas, and a wired drone group having a plurality of drones. The wired drone group includes a plurality of drones (1) coupled in series by a wired cable (2) having a function for performing power feeding to the respective drones and/or communication with the respective drones (1), and a controller (3) connected to the drone (1) at one end side of the drone group and configured to control movement of the drone group.

### TECHNICAL FIELD

The present invention relates to a drone which is an unmanned mobile which can move in the air or in the water or in both areas, and more particularly to a wired drone group having a plurality of drones coupled by cables.

### BACKGROUND ART

A drone defined as an unmanned mobile which can move in the air or in the water or in both areas is widely used in various fields such as photographing or monitoring, checking or inspecting, or measuring.

The drone moves autonomously according to a preset object or is maneuvered using a wireless means (one of radio wave, visible light, laser beams of every wavelength range, sonic wave, and ultrasonic wave, or any combination thereof) by a human operator, or is controlled wirelessly by an external controller (including a computer).

### CITATION LIST

### Patent Literature

Patent document 1: U.S. Pat. No. 9,387,928

Patent document 2: Japanese laid-open patent publication No. 2012-51545

### SUMMARY OF INVENTION

### Technical Problem

Among the above-described various drones, the drone which moves autonomously has no problem, but the drone which moves with a wireless command has the following problems.

An aerial drone cannot lengthen flight time in many cases except for a large-scale drone which can be equipped with a power source having a relatively large capacity (all kinds of power sources such as a battery, a storage battery, a condenser, and a fuel cell, or a fuel for combustion). It is difficult for an underwater drone to perform wireless control by radio wave having a GHz frequency band which is widely used for communication because the radio wave can hardly be transmitted in the water. Communication by ultrasonic wave or radio wave having a long wavelength is possible, but high-speed transmission of large quantities of data can hardly be performed even if an airframe of the drone is equipped with cameras and sensors.

As a means for solving these problems, there has been proposed a system in which the aerial drone or the underwater drone is connected to a maneuvering device for the operator or an external controller by wire. A part of such system has been put into practical use. Hereinafter, a line for transmitting and receiving the above signals and/or electric power to and from the drone is referred to as a wired cable.

However, in the case where the aerial drone or the underwater drone is used for arbitrary works, there is no problem in an open environment where there are no obstacles, but in an environment where there are some objects with which the wired cable is liable to be entangled, normal operation of the drone cannot be performed or the airframe cannot be recovered due to entanglement of the wired cable. As objects with which the wired cable is liable to be entangled, there are natural products such as rock, lumber, and seaweed; existing wire rods such as electric wire, hose and tube; utility poles; pipe lines; corner portions of construction objects or structural objects; and artificial objects such as arbitrary goods having complicated shapes. In these circumstances, it is difficult to cope with an environment where there are air current, water current, and the like so that the airframe and the wired cable of the drone are not entangled with the above objects only by a maneuvering method or a control method.

The present invention has been made in view of the above drawbacks. It is therefore an object of the present invention to provide a wired drone group and a control method of the wired drone group in which a wired cable is not caught by a natural object or an artificial object or is not entangled with the natural object or the artificial object in the drone group comprising a plurality of drones coupled by the wired cable.

### Solution to Problem

In order to achieve the above object, in one aspect of the present invention, there is provided a wired drone group comprising: a drone group comprising a plurality of drones coupled in series by a wired cable, the wired cable having a function for performing power feeding to the respective drones and/or communication with the respective drones; and a controller or a maneuvering device connected to the drone at one end side of the drone group and configured to control movement of the drone group.

In a preferred embodiment of the present invention, the controller or the maneuvering device moves the drone group so that the plurality of drones and the wired cable keep a substantially polygonal line relationship.

The polygonal line is defined as a line obtained by connecting line segments having various lengths and various directions in sequence. In the present specification, it is assumed that the line segment comprises a wired cable and the connecting portion of the adjacent line segments comprises a drone, and the polygonal line is defined as a line obtained by connecting the wired cables having various lengths and various directions through the drones in sequence. Therefore, the line obtained by connecting the plural wired cables through the drones includes a line having an arbitrary shape such as an arc-like line, a chevron-like line, and a waveform-like line, without being limited to a zigzag line. The drone group coupled by the plural wired cables can function as if the drone group comprises a single multijointed robot arm.

In a preferred embodiment of the present invention, the drone comprises an aerial drone, and the wired cable has a function for performing power feeding to the aerial drone.

In a preferred embodiment of the present invention, the drone comprises an underwater drone, and the wired cable has a function for performing communication with the underwater drone.

In a preferred embodiment of the present invention, the wired drone group comprises a main drone group comprising the plurality of drones coupled in series by the wired cable, and a sub-drone group which is branched at the middle of the main drone group and comprises a plurality of drones coupled in series by a wired cable.

In a preferred embodiment of the present invention, both ends of the wired cable are connected to lower portions of airframes of the two drones as an object to be coupled, whereby the wired cable is located below the airframes of the two drones as an object to be coupled during movement of the drone group.

In a preferred embodiment of the present invention, both ends of the wired cable are connected to upper portions of airframes of the two drones as an object to be coupled, whereby the wired cable is located above the airframes of the two drones as an object to be coupled during movement of the drone group.

In a preferred embodiment of the present invention, the drone has a gimbal mechanism having one or more rotating bodies rotatable around one or more axes perpendicularly arranged.

In a preferred embodiment of the present invention, one end of the wired cable is connected to one rotating body or an outer rotating body of the plural rotating bodies in the gimbal mechanism.

In a preferred embodiment of the present invention, the drone comprises a plurality of thrust generation mechanisms, each of the thrust generation mechanisms being configured to pressurize a fluid sucked from a suction port by an impeller and to discharge the pressurized fluid from a discharge port to thereby obtain a thrust force.

In a preferred embodiment of the present invention, the drone comprises a plurality of thrust generation mechanisms, each of the thrust generation mechanisms comprising a plurality of rotary blades.

In a preferred embodiment of the present invention, the airframe of the drone comprises a spherical body or a polyhedron which is subglobular, and the thrust generation mechanism is provided in the interior of the spherical body or the polyhedron.

In a preferred embodiment of the present invention, the airframe of the drone comprises a spherical body or a polyhedron which is subglobular, and the thrust generation mechanism is provided on an outer surface of the spherical body or the polyhedron.

In a preferred embodiment of the present invention, the two adjacent drones are coupled by a plurality of wired cables extending in parallel.

In a preferred embodiment of the present invention, the wired drone group further comprises a mechanism configured to change a length of the wired cable for coupling the two drones.

In a preferred embodiment of the present invention, the wired drone group further comprises a protective tube configured to cover the wired cable for coupling the two drones.

In a preferred embodiment of the present invention, at least one drone of the drone group is replaced with a deadweight or a joint.

In one aspect of the present invention, there is provided a method for controlling a wired drone group comprising a plurality of drones coupled in series by a wired cable, the method comprising: performing power feeding to the respective drones and/or performing communication with the respective drones; and moving the drone group so that the plurality of drones and the wired cable keep a substantially polygonal line relationship.

In a preferred embodiment of the present invention, when a distance between the i-th drone and the (i+1)th drone of the drone group is Li, a length of the wired cable for coupling the i-th drone and the (i+1)th drone is Lci, and a minimum distance between the drones with consideration for loosening of the wired cable for coupling the i-th drone and the (i+1)th drone is Lmini, the drone group is controlled so that Lmini≤Li≤Lci is established.

In a preferred embodiment of the present invention, when an object approach distance between the i-th drone and the object is Loi and a minimum approach distance between the i-th drone and the object is Lomini, the drone group is controlled so that Loi≥Lomini is established.

### Advantageous Effects of Invention

According to the present invention, in a wired drone group comprising a plurality of drones coupled by a wired cable, the wired cable is not caught by a natural object or an artificial object or is not entangled with the natural object or the artificial object. Therefore, each of the drones can perform a predetermined task reliably.

### BRIEF DESCRIPTION OF DRAWINGS

FIG. 1 is a schematic view showing a basic configuration of a wired drone group according to the present invention;

FIGS. 2A and 2B are schematic views showing the case where an object or objects are inspected by using the wired drone group configured as shown in FIG. 1, FIG. 2A showing an aerial drone group and FIG. 2B showing an underwater drone group;

FIG. 3 is a schematic view showing an embodiment in which a number of drones are coupled by a number of wired cables to construct a long drone group;

FIG. 4 is a schematic view showing a modified example of a wired drone group according to the present invention;

FIGS. 5A and 5B are schematic views showing a connecting method for connecting the plural drones and the plural wired cables;

FIG. 6 is a schematic view showing drones each having a gimbal mechanism;

FIG. 7 is a schematic perspective view showing an example of a thrust generation mechanism of the underwater drone;

FIG. 8 is a schematic perspective view showing an example of a thrust generation mechanism of the aerial drone;

FIGS. 9A and 9B are schematic views showing embodiments in which thrust generation mechanisms of the drone are installed on the surface of the airframe or in the interior of the airframe;

FIG. 10 is a schematic view showing an embodiment in which the adjacent drones are coupled by a plurality of wired cables extending in parallel;

FIG. 11 is a schematic view showing an embodiment in which a length of the wired cable for coupling the adjacent drones can be changed;

FIGS. 12A and 12B are schematic views showing mechanisms each for changing a length of the wired cable for coupling the drones;

FIGS. 13A and 13B are views showing an embodiment in which a protective tube is provided over the wired cable for coupling the adjacent drones, FIG. 13A being a schematic perspective view showing drones and protective tubes and FIG. 13B being a cross-sectional view taken along line A-A of FIG. 13A;

FIGS. 14A and 14B are schematic views showing embodiments in which a deadweight or a joint is provided between the drones;

FIG. 15 is a schematic view showing a method for controlling a drone group so that the drone group comprising a plurality of drones coupled by a plurality of wired cables is not caught on the object;

FIG. 16 is a schematic view showing an embodiment in which an object distance sensor is provided in the drone; and

FIG. 17 is a schematic view showing a modified example of the wired cable for coupling the drones.

### DESCRIPTION OF EMBODIMENTS

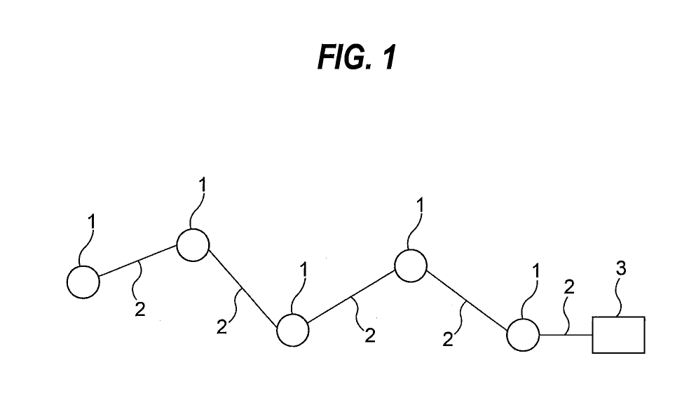

A wired drone group according to preferred embodiments of the present invention will be described below with reference to FIGS. 1 through 17. Identical or corresponding parts are denoted by identical reference numerals in FIGS. 1 through 17 and will not be described in duplication.

FIG. 1 is a schematic view showing a basic configuration of a wired drone group according to the present invention. As shown in FIG. 1, a plurality of drones 1 are coupled in series by wired cables 2 to form a drone group. Specifically, the plural drones 1 are connected in a chain-like manner by the plural wired cables 2 to form the drone group. A controller (or maneuvering device) 3 is connected to the drone 1 positioned at one end side of the drone group. The controller (or maneuvering device) 3 moves the drone group so that the plural drones 1 and the plural wired cables 2 maintain a substantially polygonal line relationship at all times, whereby the wired cables 2 are not caught by various objects or are not entangled with the various objects. The polygonal line is defined as a line obtained by connecting line segments having various lengths and various directions in sequence in Kojien (Japanese Dictionary, published by Iwanami). In the present specification, it is assumed that the line segment comprises the wired cable 2 and the connecting portion of the adjacent line segments comprises the drone 1, and the polygonal line is defined as a line obtained by connecting the wired cables 2 having various lengths and various directions through the drones 1 in sequence. Therefore, the line obtained by connecting the plural wired cables 2 through the drones 1 includes a line having an arbitrary shape such as an arc-like line, a chevron-like line, and a waveform-like line, without being limited to a zigzag line as shown in FIG. 1. The drone group coupled by the plural wired cables 2 can function as if the drone group comprises a single multijointed robot arm.

In the case where the drone is used for checking or inspecting a fluid machine such as a pump and a surrounding environment of the fluid machine, even if a battery is installed on the aerial drone, a battery capacity is small and the flight time is short, and thus it is necessary for the aerial drone to supply electric power to the drone 1 by the wired cable 2. In the underwater drone, attenuation of radio wave is large in the water or in the seawater, and thus communication by radio wave is difficult. Therefore, it is necessary for the underwater drone to ensure communication with the drones 1 by the wired cables 2. In the aerial drone also, communication may be performed by the wired cables 2. Further, in the underwater drone, power feeding may be performed by the wired cables 2. Thus, the wired cables 2 have a function for performing power feeding to the drones 1 and/or communication with the drones 1.

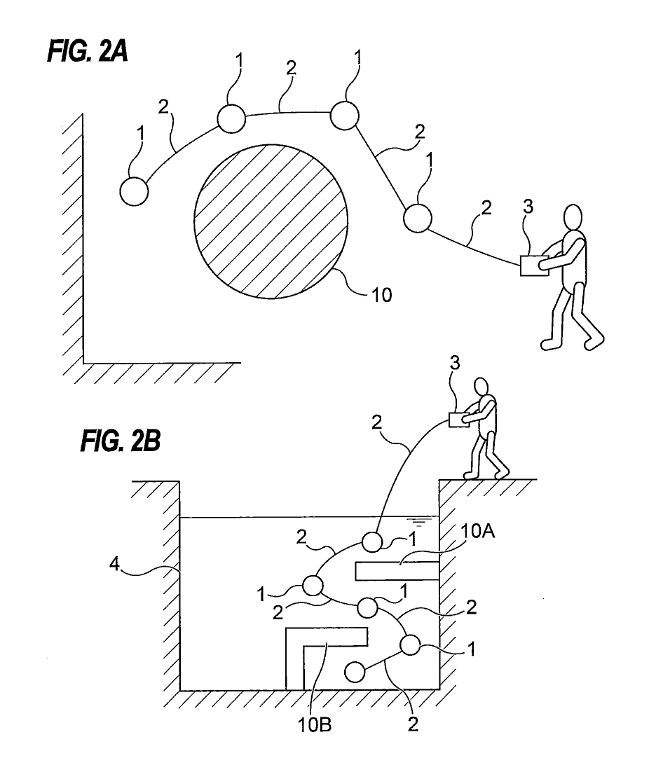

FIGS. 2A and 2B are schematic views showing the case where an object or objects are inspected by using the wired drone group configured as shown in FIG. 1. FIG. 2A shows an aerial drone group, and FIG. 2B shows an underwater drone group.

As shown in FIG. 2A, the drone group comprising the plural drones 1 coupled by the plural wired cables 2 is controlled by the controller (or maneuvering device) 3, and the drone group moves in the air to a position where the drone group surrounds a columnar object 10 to be inspected from above and obliquely from the side, and inspects the object 10. The controller (or maneuvering device) 3 has a built-in power source and supplies electric power to the plural drones 1 by the plural wired cables 2. The communication between the controller (or maneuvering device) 3 and the plural drones 1 may be performed through radio wave or may be performed through the wired cables 2. The controller (or maneuvering device) 3 controls the drone group so that the distance between the adjacent drones is kept at a predetermined interval and the distance between each drone 1 and the object 10 such as piping to be inspected is kept at an interval suitable for inspection. In this manner, the plural drones 1 and the plural wired cables 2 keep a substantially polygonal line relationship at all times.

As shown in FIG. 2B, the drone group comprising the plural drones 1 coupled by the plural wired cables 2 is controlled by the controller (or maneuvering device) 3, and the drone group moves in the water to a position where the drone group surrounds an object 10A, to be inspected, having a rectangular cross section and an object 10B, to be inspected, having an L-shaped cross section in a water tank 4 from above and below and from the side, and inspects the objects 10A, 10B. The controller (or maneuvering device) 3 controls the drone group so that the distance between the adjacent drones is kept at a predetermined interval and the distance between each drone 1 and each of the objects 10A, 10B to be inspected is kept at an interval suitable for inspection. In this manner, the plural drones 1 and the plural wired cables 2 keep a substantially polygonal line relationship at all times.

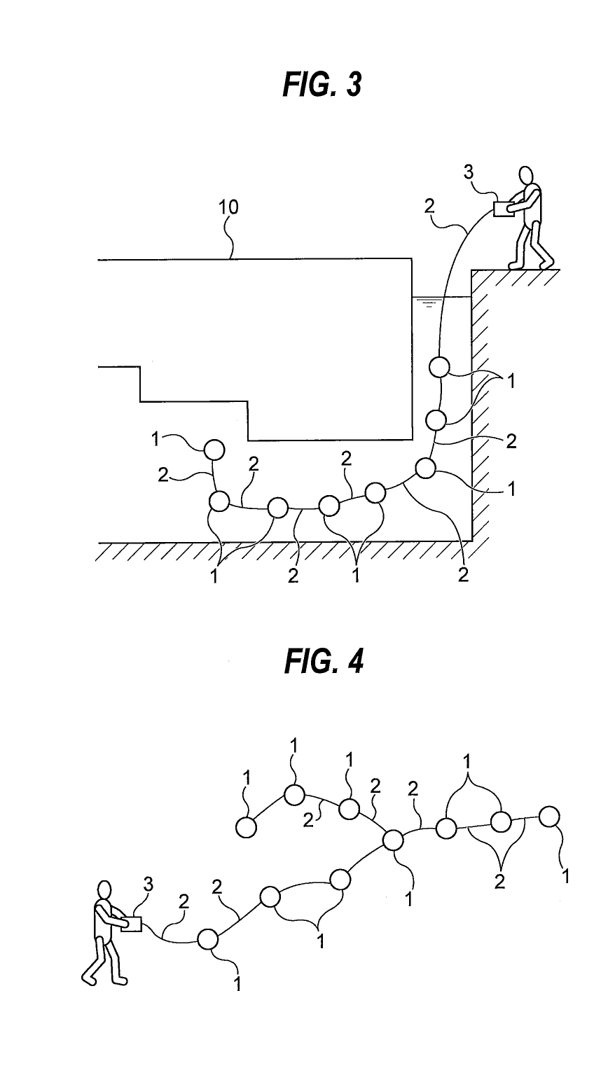

FIG. 3 is a schematic view showing an embodiment in which a number of drones 1 are coupled by a number of wired cables 2 to construct a long drone group. As shown in FIG. 3, in the case where an object 10 to be inspected comprises a large-size structural object such as a pump facility, a number of drones 1 are coupled by a number of wired cables 2 to construct a long drone group. The controller (or maneuvering device) 3 controls the long drone group, and the drone group moves in the water to a position where the drone group surrounds a lower surface and lower side surfaces of the large-size object 10 to be inspected, and inspects the object 10. The controller (or maneuvering device) 3 controls the drone group so that the distance between the adjacent drones is kept at a predetermined interval and the distance between each drone 1 and the object 10 to be inspected is kept at an interval suitable for inspection. In this manner, the many drones 1 and the many wired cables 2 keep a substantially polygonal line relationship at all times.

FIG. 4 is a schematic view showing a modified example of a wired drone group according to the present invention. As shown in FIG. 4, the wired drone group comprises a main drone group comprising a plurality of drones 1 coupled in series by a plurality of wired cables 2, and a sub-drone group which is branched at the middle of the main drone group. The sub-drone group also comprises a plurality of drones 1 coupled in series by a plurality of wired cables 2.

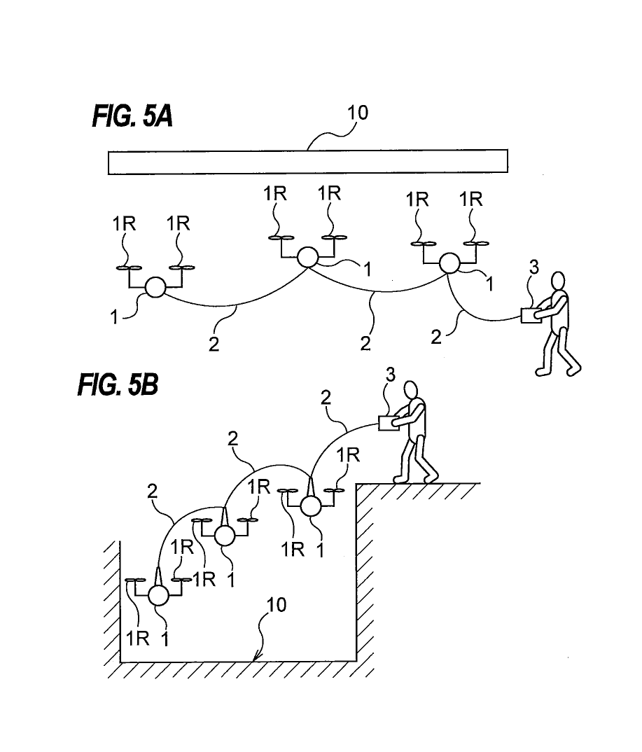

FIGS. 5A and 5B are schematic views showing a connecting method for connecting the plural drones 1 and the plural wired cables 2. FIGS. 5A and 5B show the aerial drones. The same holds true for the underwater drones.

FIG. 5A is a schematic view showing a connecting method for connecting the plural drones 1 and the plural wired cables 2 in the case where an object 10 to be inspected is located above the operator (i.e., controller (or maneuvering device) 3). As shown in FIG. 5A, in the case where the object 10 to be inspected is located above the operator (i.e., controller (or maneuvering device) 3), both ends of each of the wired cables 2 are connected to lower portions of the airframes of the two drones 1 as an object to be connected, whereby each of the wired cables 2 is positioned below the airframes of the two drones 1 as an object to be connected during the flight. Thus, each of the wired cables 2 is prevented from being brought into contact with a rotary blade 1R of the drone 1.

FIG. 5B is a schematic view showing a connecting method for connecting the plural drones 1 and the plural wired cables 2 in the case where an object 10 to be inspected is located below the operator. As shown in FIG. 5B, in the case where the object 10 to be inspected is located below the operator (i.e., controller (or maneuvering device) 3), both ends of each of the wired cables 2 are connected to upper portions of the airframes of the two drones 1 as an object to be connected, whereby each of the wired cables 2 is positioned above the airframes of the two drones 1 as an object to be connected during the flight. Thus, each of the wired cables 2 is prevented from being brought into contact with a rotary blade 1R of the drone 1.

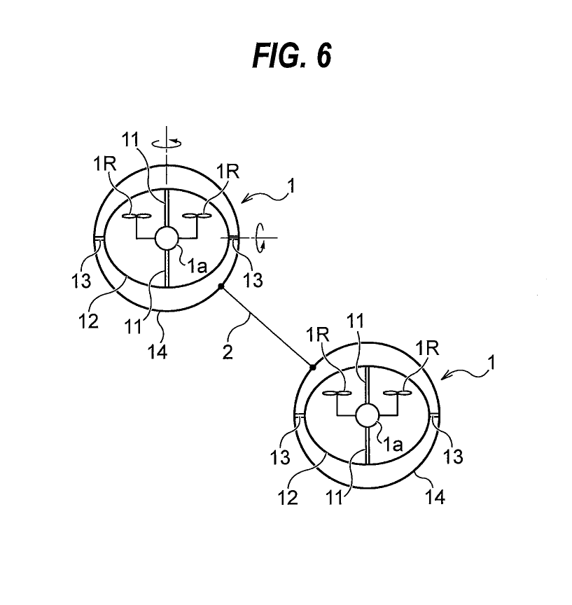

FIG. 6 is a schematic view showing drones each having a gimbal mechanism. The drone 1 shown in FIG. 6 has a gimbal mechanism. The gimbal mechanism comprises a first shaft 11 extending vertically from a drone body la having a rotary blade 1R, an inner ring (inner side rotating body) 12 rotatable around an axis of the first shaft 11, a second shaft 13 extending radially outwardly from the inner ring 12 and being perpendicular to the first shaft 11, and an outer ring (outer side rotating body) 14 comprising a ring larger than the inner ring 12 and being rotatable around an axis of the second shaft 13. As shown in FIG. 6, according to the drone 1 having the gimbal mechanism, the outer ring 14 can be rotated in any direction of 360° in a state where the posture of the drone body la is maintained as it is.

As shown in FIG. 6, the two drones 1 each having the gimbal mechanism are coupled by connecting the outer rings 14 together with the wired cable 2. Because each of the outer rings 14 of the two drones 1 can be rotated in any direction of 360°, the distance between the two drones 1 can be kept constant while a tension is applied at all times to the wired cable 2 which connects the outer rings 14 together. The wired cable 2 performs power feeding to the drone body la and/or communication with the drone body la through the gimbal mechanisms.

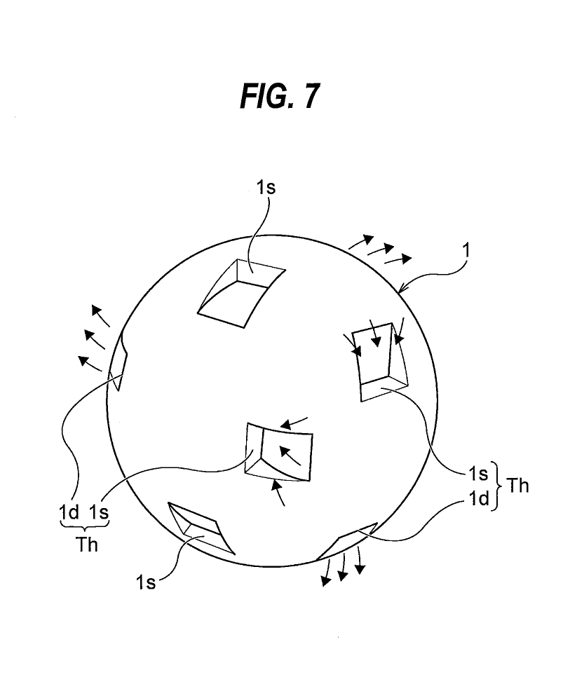

FIG. 7 is a schematic perspective view showing an example of a thrust generation mechanism of the underwater drone 1. As shown in FIG. 7, the airframe of the drone 1 comprises a spherical body, and a plurality of axial flow thrusters Th each having a pair of a suction port is and a discharge port 1d are provided in an entire surface of the spherical body. Each axial flow thruster Th has an axial flow impeller (arranged in the interior of the airframe) between the suction port is and the discharge port 1d, whereby a fluid (water) sucked from the suction port 1s is pressurized by the axial flow impeller and the pressurized fluid (water) is discharged from the discharge port 1d to obtain a thrust force. Because the axial flow thrusters Th are dispersed over the entire surface of the spherical body, the drone 1 can obtain a propulsion force in any direction. The airframe of the drone 1 may be a polyhedron which is subglobular.

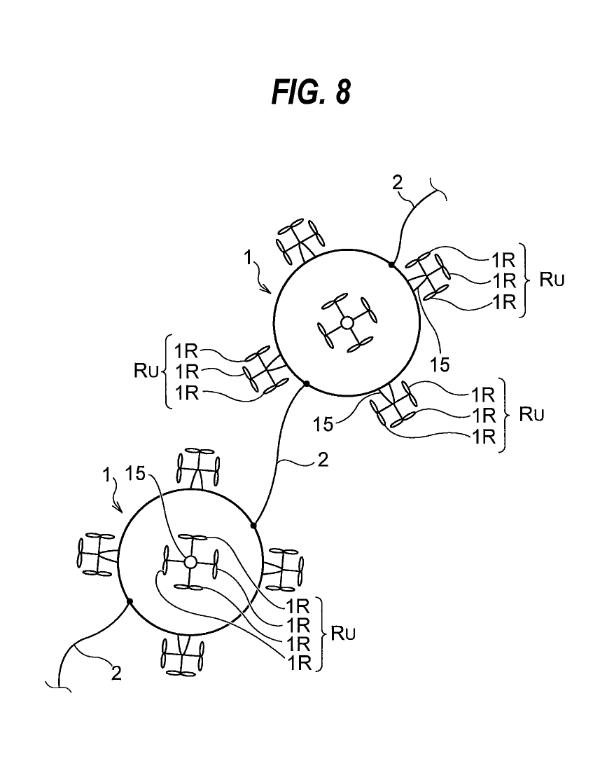

FIG. 8 is a schematic perspective view showing an example of a thrust generation mechanism of the aerial drone 1. As shown in FIG. 8, the airframe of the drone 1 comprises a spherical body, and the center of gravity of the airframe is located near a center of the sphere. The wired cable 2 is fixed to the spherical body. A plurality of rotary blade units Ru are provided on the entire surface of the spherical body. In the illustrated example, one rotary blade unit Ru is provided on the upper portion of the spherical body, four rotary blade units Ru are provided on the side portions of the spherical body at equal intervals, and one rotary blade unit Ru (not shown) is provided on the lower portion of the spherical body. Thus, a total of six rotary blade units Ru is provided. Each of the rotary blade units Ru has a plurality of rotary blades 1R supported by supports 15 fixed to the spherical body. In the illustrated example, one rotary blade 1R is provided in an axial direction of the support 15, and four rotary blades 1R are provided at equal intervals around an axis of the support 15. Thus, a total of five rotary blades 1R is provided. As shown in FIG. 8, because the rotary blade units Ru each having the plural rotary blades 1R are dispersed over the entire surface of the spherical body, the drone 1 can obtain a propulsion force in any direction. The airframe of the drone 1 may be a polyhedron which is subglobular.

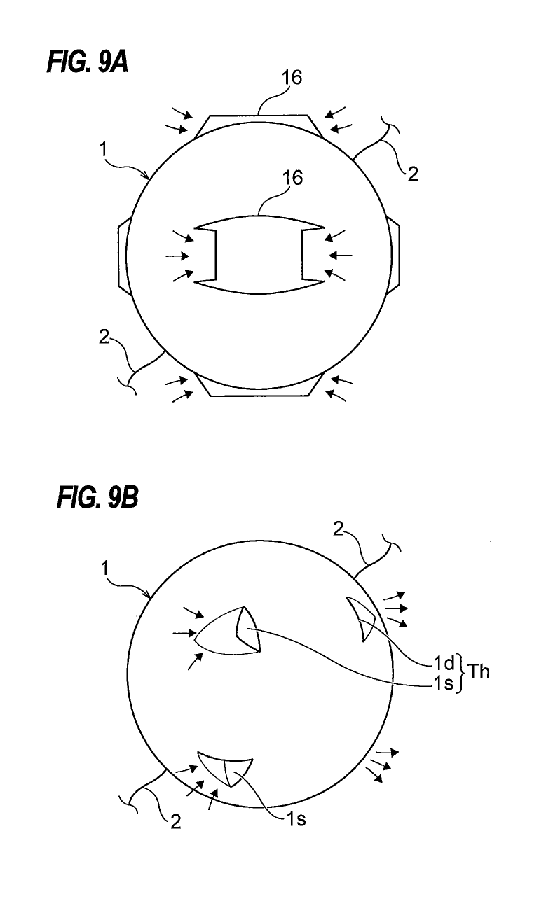

FIGS. 9A and 9B are schematic views showing embodiments in which thrust generation mechanisms of the drone 1 are installed on the surface of the airframe or in the interior of the airframe.

In the drone 1 shown in FIG. 9A, recesses are formed in a surface of a spherical airframe, thrust generation mechanisms are installed in the recesses, and the thrust generation mechanisms are covered with covers 16. The thrust generation mechanism is the same as that shown in FIG. 7.

In the drone 1 shown in FIG. 9B, thrust generation mechanisms are installed in the interior of the spherical airframe. The thrust generation mechanism is the same as that shown in FIG. 7.

As shown in FIGS. 9A and 9B, because the thrust generation mechanisms are installed on the surface of the airframe or in the interior of the airframe, the wired cable 2 can be prevented from being caught on the thrust generation mechanism. The airframe of the drone 1 may be a polyhedron which is subglobular.

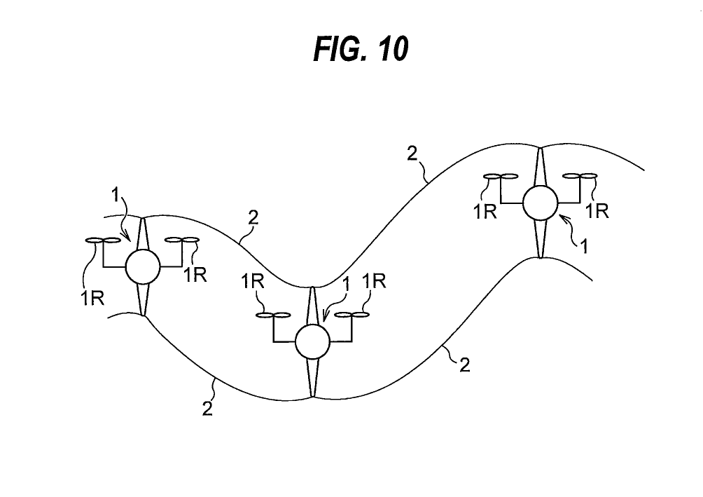

FIG. 10 is a schematic view showing an embodiment in which the adjacent drones 1 are coupled by a plurality of wired cables 2 extending in parallel. In the example shown in FIG. 10, the two adjacent drones 1 are coupled by the two wired cables 2 extending in parallel. In this manner, because the two adjacent drones 1 are coupled by the two wired cables 2, an electric power line and a signal line may be separated or power feeding may be performed by two electric power lines.

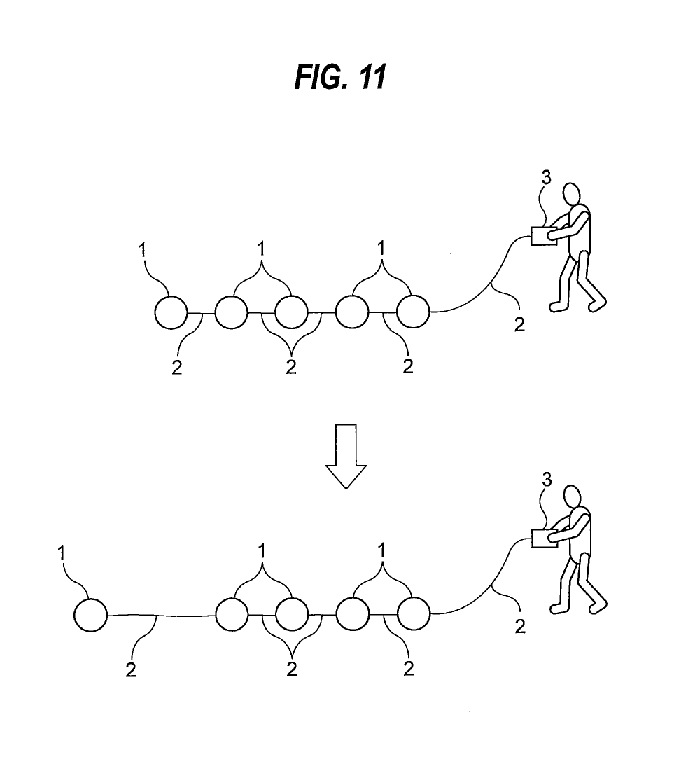

FIG. 11 is a schematic view showing an embodiment in which a length of the wired cable 2 for coupling the adjacent drones 1 can be changed. In the example shown in FIG. 11, the wired cable 2 between the forefront drone 1 and the subsequent drone 1 is changed in length from an upper state to a lower state. The other wired cables 2 can be changed in length in the same manner. The length of the wired cable 2 may be changed during movement of the drone group or during inspection of the object.

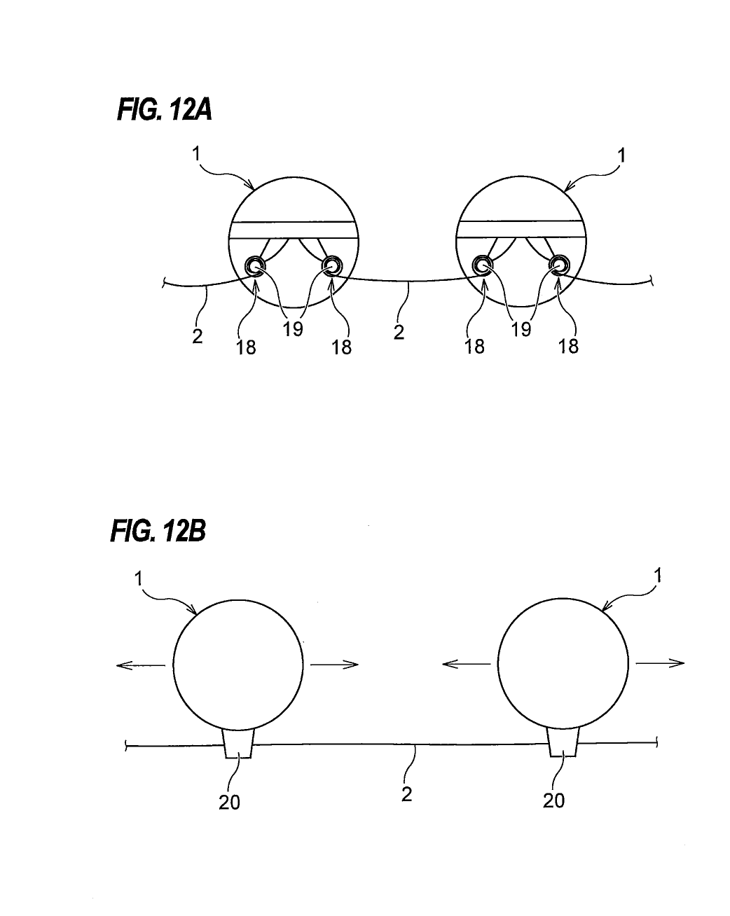

FIGS. 12A and 12B are schematic views showing mechanisms each for changing a length of the wired cable 2 for coupling the drones 1.

In the example shown in FIG. 12A, each drone 1 has two cable hoisting mechanisms 18 for hoisting and rewinding of the wired cable 2 connected to the drone 1. Each cable hoisting mechanism 18 is configured to perform hoisting and rewinding of the wired cable 2 by forward and reverse rotation of a reel 19 by a motor. Thus, the wired cable 2 for coupling the two drones 1 can be kept at an optimum length depending on the object to be inspected.

In the example shown in FIG. 12B, each drone 1 is movable along the wired cable 2 so that the position of the drone 1 can be changed with respect to the wired cable 2. When each drone 1 moves along the wired cable 2, the thrust generation mechanism provided in each drone 1 may be operated or a moving mechanism may be provided separately from the thrust generation mechanism. Each drone 1 has a clamping mechanism 20, and the drone 1 is movable along the wired cable 2 when the clamping mechanism 20 is in a released state. When the position of the drone 1 is determined on the wired cable 2, the clamping mechanism 20 is operated to fix the drone 1 to the wired cable 2. Thus, the wired cable 2 for coupling the two drones 1 can be kept at an optimum length depending on the object to be inspected. The wired cable 2 performs power feeding to the drone 1 and/or communication with the drone 1 through the clamping mechanism 20.

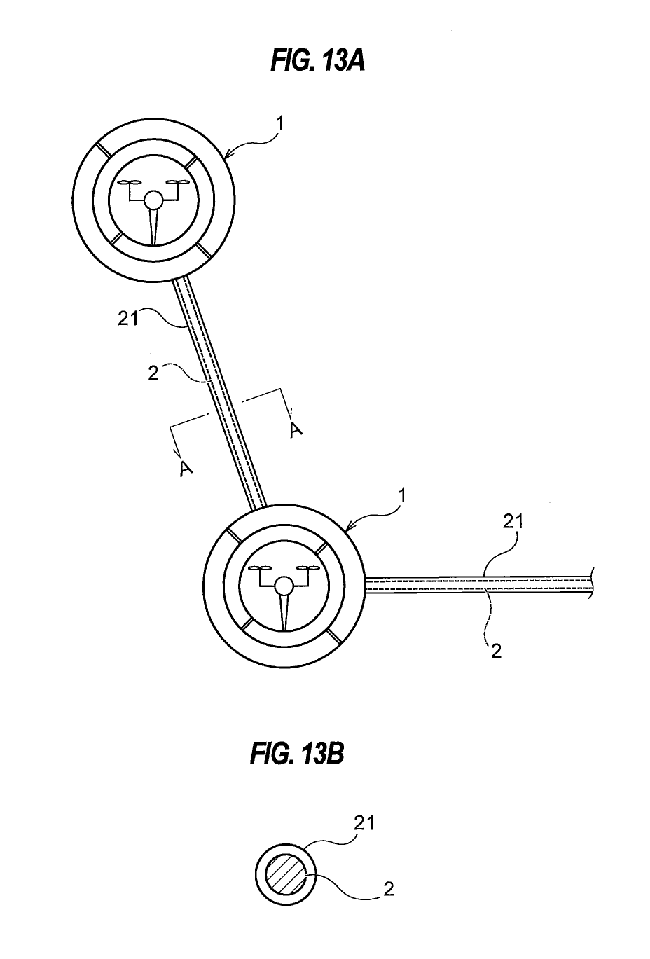

FIGS. 13A and 13B are views showing an embodiment in which a protective tube is provided over the wired cable 2. FIG. 13A is a schematic perspective view showing drones 1 and protective tubes 21, and FIG. 13B is a cross-sectional view taken along line A-A of FIG. 13A.

As shown in FIGS. 13A and 13B, a protective tube 21 is provided to cover the wired cable 2 for coupling the drones 1. The protective tube 21 is made of a resin material or a light metal or a wood or a paper, or a composite material of these materials which has a light weight and is inflexible, and the protective tube 21 connects the drones 1 linearly. Therefore, the protective tube 21 makes the same movement as the robot arm and performs a function for keeping the distance between the drones 1 constant at all times. Thus, the risk that the wired cable 2 is caught on the object due to cable loosening can be reduced. As with the embodiment shown in FIG. 6, each drone 1 has a gimbal mechanism.

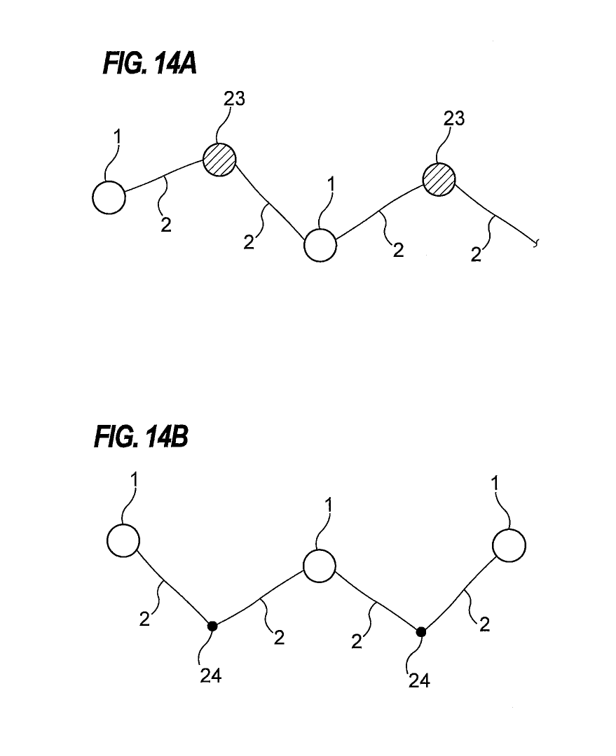

FIGS. 14A and 14B are schematic views showing embodiments in which a deadweight or a joint is provided between the drones 1.

In the embodiments shown in FIGS. 1 through 13, the plural drones 1 are coupled by the plural wired cables 2. In the embodiment shown in FIG. 14A, a deadweight 23 is provided between the two drones 1. Further, in the embodiment shown in FIG. 14B, a joint 24 is provided between the two drones 1. As shown in FIGS. 14A and 14B, because the deadweight 23 or the joint 24 is provided in place of the drone 1, the number of drones to be controlled can be reduced. In the case where the embodiment in which the deadweight 23 is provided is applied to the underwater drone group, because the deadweight 23 maintains a substantially stationary state in the water, the other drones 1 can be moved in a state where the position of the deadweight 23 acts as a fixed point. In the case where the embodiment in which the joint 24 is provided is applied to the drone group, the combined use of the protective tube 21 shown in FIGS. 13A and 13B leads to a mode as if the two robot arms are connected by the joint 24. Therefore, the risk that the wired cable 2 is caught on the object can be further reduced.

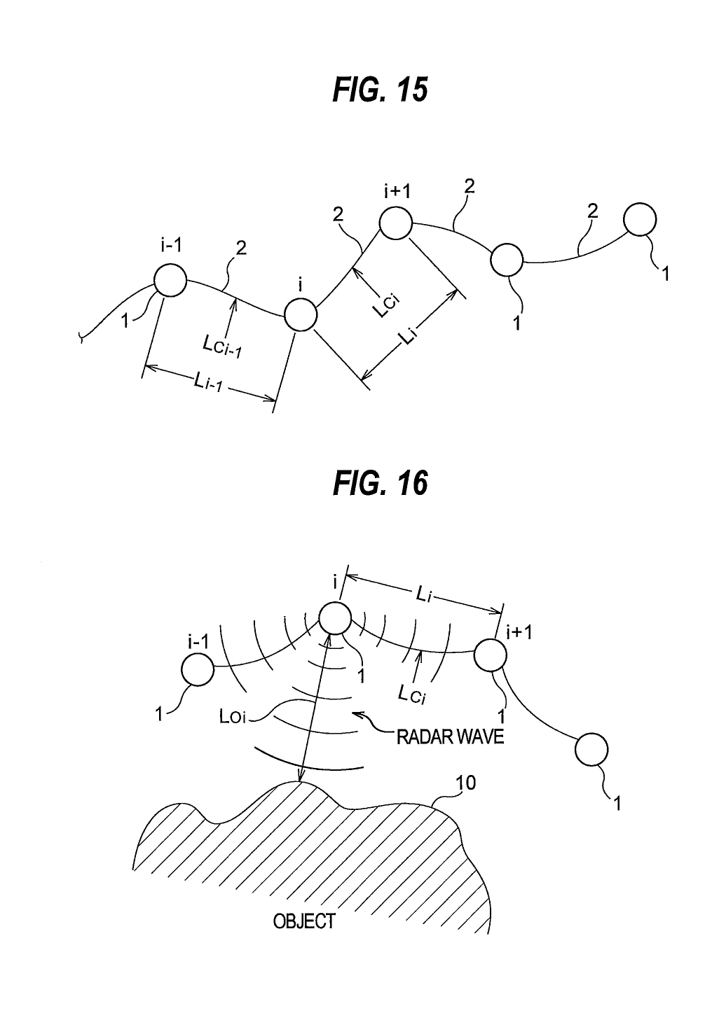

FIG. 15 is a schematic view showing a method for controlling a drone group so that the drone group comprising a plurality of drones 1 coupled by a plurality of wired cables 2 is not caught on the object.

As shown in FIG. 15, a number i, 1+1, and the like is assigned to each of the drones 1 constituting the drone group. Here, when the distance between the i-th drone and the (i+1)th drone is Li, the length of the wired cable 2 for coupling the i-th drone 1 and the (i+1)th drone 1 is Lci, and the minimum distance between the drones with consideration for loosening of the wired cable 2 for coupling the i-th drone 1 and the (i+1)th drone 1 is Lmini, it is necessary to control the drone group so that the following equation (1) is established.

Lmini≤Li≤Lci (1)

In the equation (1), because excessive cable loosening of the wired cable 2 becomes a cause of the wired cable 2 caught on the object, the minimum distance Lmini between the drones is set to a distance to prevent the wired cable 2 from being sagged excessively. Further, by controlling the two drones 1 so that the distance Li between the drones becomes equal to or shorter than the length Lci of the wired cable 2, the wired cable 2 is controlled in a state where the wired cable 2 can be pulled tight or the wired cable 2 can become slightly loose.

In the case where the drone group comprises n number of the drones 1, an orbit of each drone 1 is predetermined so that n number of the drones 1 satisfy the restraint condition of the equation (1), and each drone 1 is controlled and moved according to the determined orbit. The control may be any one of an open-loop control and a closed-loop control. The position of the drone required for controlling may be determined by using a position sensor installed in the drone 1 or images from the outside or measurement by a radar, ultrasonic wave, or the like, or the combination thereof.

FIG. 16 is a schematic view showing an embodiment in which an object distance sensor is provided in the drone. As shown in FIG. 16, the i-th drone 1 is equipped with an object distance sensor, and the object distance sensor outputs a radar wave, for example, and measures a distance between the i-th drone 1 and the (i−1)th drone 1, a distance between the i-th drone 1 and the (i+1)th drone 1, and a distance between the i-th drone 1 and the object 10. Signals representing the respective measured distances are sent to the controller (or maneuvering device). The controller (or maneuvering device) controls the drones so that the i-th drone 1, the (i−1)th drone 1 and the (i+1)th drone 1 keep proper distances therebetween. Specifically, the drone group is controlled so that the above equation (1) is established. Further, when the object approach distance between the i-th drone 1 and the object 10 is Loi and the minimum approach distance between the i-th drone 1 and the object 10 is Lomini, it is necessary to control the drone group so that the following equation (2) is established.

Loi≤Lomini (2)

In the case where the drone group comprises n number of the drones 1, an orbit of each drone 1 is predetermined so that n number of the drones 1 satisfy the restraint conditions of the equations (1) and (2), and each drone 1 is controlled and moved according to the determined orbit.

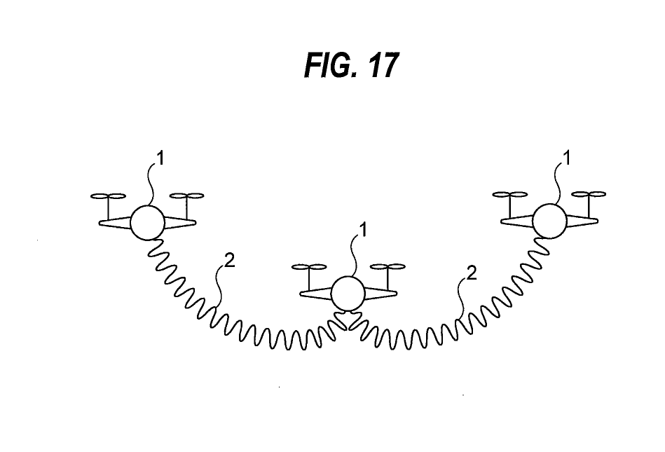

FIG. 17 is a schematic view showing a modified example of the wired cable 2 for coupling the drones 1. As shown in FIG. 17, the wired cable 2 for coupling the drones 1 may comprise a coiled elastic cable.

While the present invention has been described with reference to the embodiments, it is understood that the present invention is not limited to the embodiments described above, but is capable of various changes and modifications within the scope of the inventive concept as expressed herein.

### INDUSTRIAL APPLICABILITY

The present invention is applicable to a drone which is an unmanned mobile which can move in the air or in the water or in both areas, and a drone group having a plurality of drones.

### REFERENCE SIGNS LIST

1 drone

1a drone body

1s suction port

1d discharge port

1R rotary blade

2 wired cable

3 controller (or maneuvering device)

4 water tank

10, 10A, 10B object

11 first shaft

12 inner ring

13 second shaft

14 outer ring

15 support

16 cover

18 cable hoisting mechanism

19 reel

20 clamping mechanism

21 protective tube

23 deadweight

24 joint

Th axial flow thruster

Ru rotary blade unit

1. A wired drone group comprising:
a drone group comprising a plurality of drones coupled in series by a wired cable, the wired cable having a function for performing power feeding to the respective drones and/or communication with the respective drones; and
a controller or a maneuvering device connected to the drone at one end side of the drone group and configured to control movement of the drone group.

2. The wired drone group according to claim 1, wherein the controller or the maneuvering device moves the drone group so that the plurality of drones and the wired cable keep a substantially polygonal line relationship.

3. The wired drone group according to claim 1, wherein the drone comprises an aerial drone, and the wired cable has a function for performing power feeding to the aerial drone.

4. The wired drone group according to claim 1, wherein the drone comprises an underwater drone, and the wired cable has a function for performing communication with the underwater drone.

5. The wired drone group according to any one of claims 1, wherein the wired drone group comprises a main drone group comprising the plurality of drones coupled in series by the wired cable, and a sub-drone group which is branched at the middle of the main drone group and comprises a plurality of drones coupled in series by a wired cable.

6. The wired drone group according to any one of claims 1, wherein both ends of the wired cable are connected to lower portions of airframes of the two drones as an object to be coupled, whereby the wired cable is located below the airframes of the two drones as an object to be coupled during movement of the drone group.

7. The wired drone group according to any one of claims 1, wherein both ends of the wired cable are connected to upper portions of airframes of the two drones as an object to be coupled, whereby the wired cable is located above the airframes of the two drones as an object to be coupled during movement of the drone group.

8. The wired drone group according to any one of claims 1, wherein the drone has a gimbal mechanism having one or more rotating bodies rotatable around one or more axes perpendicularly arranged.

9. The wired drone group according to claim 8, wherein one end of the wired cable is connected to one rotating body or an outer rotating body of the plural rotating bodies in the gimbal mechanism.

10. The wired drone group according to any one of claims 1, wherein the drone comprises a plurality of thrust generation mechanisms, each of the thrust generation mechanisms being configured to pressurize a fluid sucked from a suction port by an impeller and to discharge the pressurized fluid from a discharge port to thereby obtain a thrust force.

11. The wired drone group according to any one of claims 1, wherein the drone comprises a plurality of thrust generation mechanisms, each of the thrust generation mechanisms comprising a plurality of rotary blades.

12. The wired drone group according to claim 10, wherein the airframe of the drone comprises a spherical body or a polyhedron which is subglobular, and the thrust generation mechanism is provided in the interior of the spherical body or the polyhedron.

13. The wired drone group according to claim 10, wherein the airframe of the drone comprises a spherical body or a polyhedron which is subglobular, and the thrust generation mechanism is provided on an outer surface of the spherical body or the polyhedron.

14. The wired drone group according to any one of claims 1, wherein the two adjacent drones are coupled by a plurality of wired cables extending in parallel.

15. The wired drone group according to any one of claims 1, further comprising a mechanism configured to change a length of the wired cable for coupling the two drones.

16. The wired drone group according to any one of claims 1, further comprising a protective tube configured to cover the wired cable for coupling the two drones.

17. The wired drone group according to any one of claims 1, wherein at least one drone of the drone group is replaced with a deadweight or a joint.

18. A method for controlling a wired drone group comprising a plurality of drones coupled in series by a wired cable, the method comprising:
performing power feeding to the respective drones and/or performing communication with the respective drones; and
moving the drone group so that the plurality of drones and the wired cable keep a substantially polygonal line relationship.

19. The method for controlling a wired drone group according to claim 18, wherein when a distance between the i-th drone and the (i+1)th drone of the drone group is Li, a length of the wired cable for coupling the i-th drone and the (i+1)th drone is Lci, and a minimum distance between the drones with consideration for loosening of the wired cable for coupling the i-th drone and the (i+1)th drone is Lmini, the drone group is controlled so that Lmini≤Li≤Lci is established.

20. The method for controlling a wired drone group according to claim 19, wherein when an object approach distance between the i-th drone and the object is Loi and a minimum approach distance between the i-th drone and the object is Lomini, the drone group is controlled so that Loi Lomini is established.
